(19) United States
(12) Patent Application Publication
(10) Pub. No.: US 2009/0068628 A1
(43) Pub. Date: Mar. 12, 2009

(54) Apparatus and Method for Cyber Healthcare Monitoring, With Calibration Using Thin Client Communicating Techniques

(76) Inventor: Rocco Martino, Villanova, PA (US)

Correspondence Address: Law Office of Scott C Harris Inc, PO Box 1389, Rancho Santa Fe, CA, 92067, US

(21) Appl. No.: 12/206,145

(22) Filed: Sep. 8, 2008

Related U.S. Application Data
(60) Provisional application No. 60/970,889, filed on Sep. 7, 2007.

(51) Int. Cl. G09B 23/28

(52) U.S. Cl. 434/268

(57) ABSTRACT

A moving part with fluid detection therein. e.g., a body.
Information indicative of the small body is

This application claims priority from Provisional application No. 60/970,889 filed Sep. 7, 2007 the entire contents of which are herewith incorporated by reference.

### BACKGROUND

Various devices have been progressed for predicting, monitoring, controlling, and treating heart attacks, strokes, and cancer.

Visualization methodology has been in use for years, systems such as X-Rays, MRI, and Scans of various types. These devices are calibrated in some fashion in order to correlate the findings and measurements of such instruments to the reality condition of the body or body part being examined.

An apparatus and methodology of calibration has been invented as will be described in this application.

The need for calibration is apparent in considering the magnitude of the problem associated with heart attacks alone. Each year, approximately 543,000 men and 399,000 women suffer heart attacks. In part because women have heart attacks at older ages than men do, women are more likely to die from an attack within a few weeks. Of the approximately 500,000 fatal heart attacks per year in the U.S., nearly half occur in women.

Expenditures for coronary heart disease in the U.S. were estimated to exceed $142.1 billion in 2005. Estimated deaths worldwide due to coronary heart disease total 7.1 million per year.

In early inventions covered by patent numbers U.S. Pat. Nos. 5,805,676; 5,987,103; 6,044,382; 6,574,314; and 6,973,477, and invented by a common inventor to the present invention, the objective of the methodology and devices was ways to create, manipulate, and retrieve data with a minimum of computer hardware and software. These inventions concerned digital two-way communication methodology, wired and/or wireless, for data transport with minimal devices linked to multi-tier systems, including linkages to grid systems and databases on a global basis. This data in turn would represent multi-media text, images, pictures, video. These data are carried or transmitted on signals at different frequencies of the visible and invisible spectrum; as for example infra-red, radio signals, low power FM, and the like. In fact, any signal that would establish a communication path or circuit can transmit these data.

This work has produced patents such as U.S. Pat. No. 7,334,024, having a common inventor to the present invention and a priority date of May 19, 1995. These include systems, among other things, for medical monitoring in wireless mode using minimal hardware with the patented thin client (which can, for example, require less than 250 Kbytes of resource in actual development) linked to control servers. In these patents, this thin client was referred to as TAS for Transaction Assembly or Application Server. In the terminology of today, this might be labeled a browser or thin client. In commercial use, this mobile browser is often called an Application Generator Engine (“AGE”) and acts as a virtual application.

AGE is turn is linked to a control server, internal or external, that is called BOSS, for Broad Operations System Server. Hence FIG. 1, the initial diagram of the multi-tier system from these patent applications is redrawn here. The end result is the ability to communicate with minimal hardware/software in the monitoring device.

Hence U.S. Pat. No. 5,805,676, Telephone/transaction entry device and system for entering transaction data into databases described a three tier transaction processing system that establishes a virtual application platform capable of supporting an almost limitless variety of applications; all defined as streams of data generated from and distributed to devices capable of handling a stream of data as shown in FIG. 1.

### SUMMARY

Two major developments: nano technology and communication technology, when combined, can provide far-reaching diagnostic and monitoring capability in human and animal healthcare and research.

An embodiment describes using small materials within a living body to send information to a server using thin client techniques.

### BRIEF DESCRIPTION OF THE DRAWINGS

FIG. 1 shows the basic architectural layout of the system;

FIG. 2 shows the way in which clients interact with the servers;

FIG. 3 shows how physicians can interact with the remote server; and

FIG. 4 shows information about different embodiments.

### DETAILED DESCRIPTION

A device-agnostic single “thin” program, in combination with a device or devices, can accommodate machine readable data generated from sensors of various types that can measure pressure flow, temperature, heart rate, chemical composition of gaseous substances—or devices such as video or still cameras, that capture voice, audio, text or graphic data. Our granted patents noted above, explain in increasing level of detail, aspects of the three-tier system embodied in the original patent. Remote patient status monitoring and measurement across any two-way communication network or multiple networks worldwide is but one type of application identified in patent U.S. Pat. No. 5,805,676.

This system is usable with our currently filed application, (conversion of 60/970,875) filed Sep. 8, 2008, the entire contents of the disclosure of which is herewith incorporated by reference.

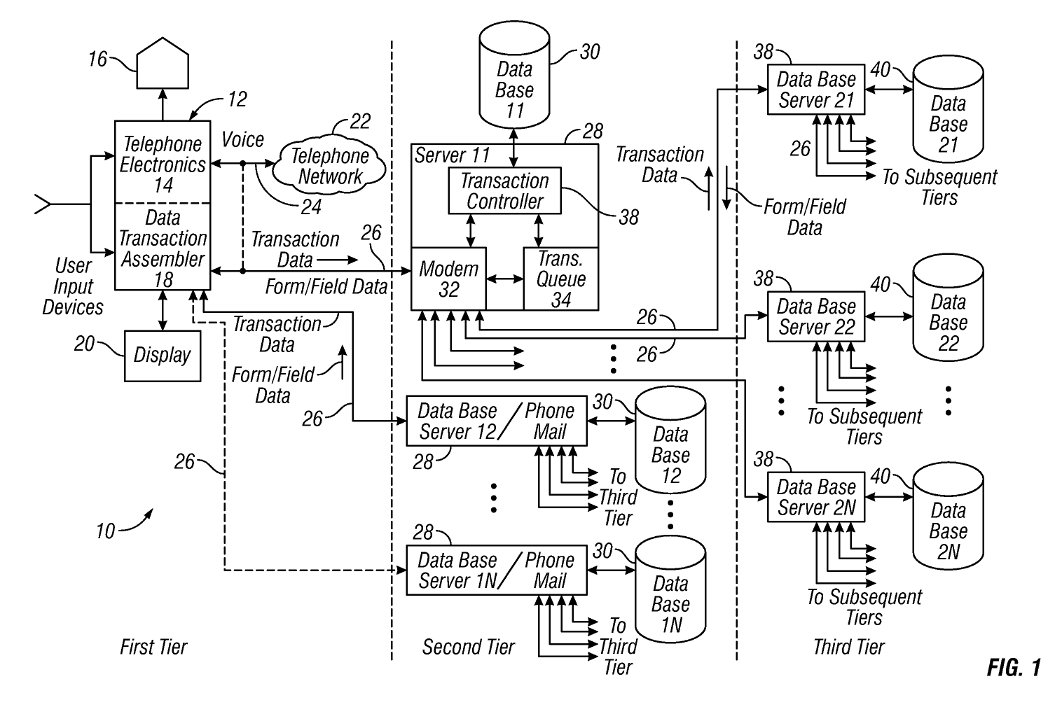

An embodiment describes using thin technology, e.g., the techniques described above, for monitoring and diagnosis can be carried out over a network such as the internet, with any type of monitoring/measurement device with a microchip capability to include the basic patented mobile browser (TAS of U.S. Pat. No. 6,044,382 Data Transaction Assembly Server). This module could occupy a minimal on-line storage capacity. Embodiments can use cell-phones, PDAs and/or other thin clients for this purpose. Furthermore, any kind of device that contains sufficient power and micro capacity to make a TAS function would be sufficient to connect to any monitoring or measurement system anywhere as shown in FIG. 1. Examples of such devices are wrist units with or without location (GPS) and/or time capability.

Another manifestation of this would be a pad or module that could be attached inside or outside the body anywhere. The power requirements of one such embodiment could be met using the same kind of batteries used in heart monitors and heart pacers.

The operating nature of this monitoring device, whether in the body, on the body, on the wrist, or in some device as a cell phone, would receive signals from implanted devices that are within the body. This specification refers to these devices as “nano” devices; however more generally, these devices can be of any size that allows them to be implanted within the body. The devices can be self-powered, or externally pollable.

As indicated, a specially crafted wrist-monitoring or other portable device, that includes the TAS, may be considered as another embodiment of the data transaction terminal described in our patents. The data entry device could include position location (GPS), and could also have the patented thin-client installed or not.

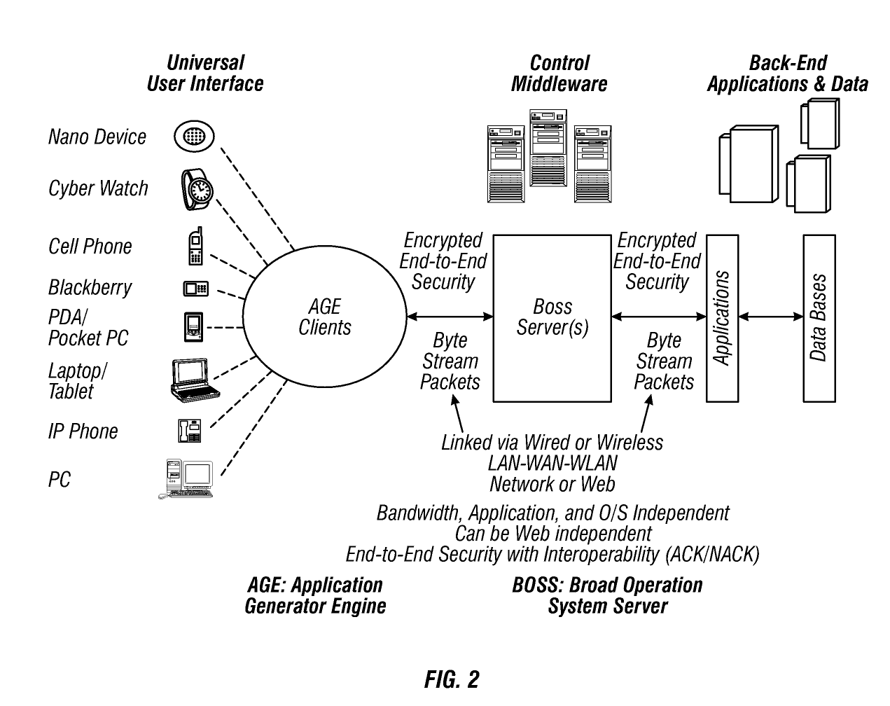

FIG. 1 and FIG. 2 relates this patented concept to the health-care world, making it possible to monitor any person or animal anywhere at all times. In this figure, the term UNI-LINK® is used as a description of the overall system of thin client, middleware, and the Grid universe. When a data entry device that includes a display, data entry capability and a modem, also includes a TAS, it then becomes a data transaction terminal; without a TAS, the device containing the other elements is then a data entry device. In fact, any data transaction terminal is also a data entry device.

The monitoring can serve to provide for geographic location, safety and emergency information, alerts and logic-based instructions, or measurement of some vital sign with appropriate logic-based prescriptive directions, sent to any and all interested parties as well as the subject. All communication is made on a real time basis, or can be stored for analysis and periodic checking.

Another important component of an embodiment is the implantable device itself, e.g., a nano device and/or small sized device.

Advances in nano technology have progressed to the point where small sized devices of various shapes can be made that are close to atomic scale in size—at the micron level (one millionth of a meter), and in future at the milli-micron level. At this time, various devices have been manufactured at a dimension of less than 7 microns. Advanced processes are likely to lead to even smaller sized small particles. The term “nano device” or “small device” is intended to cover any electronic device of a size less than 7 microns.

An embodiment places the small devices within the body of the living animal or person. These can be injected into the blood stream to freely circulate through the arteries, veins and capillaries of the body; or they can be implanted in the body or in organs, or close to organs and blood vessels. Wherever they are placed, they can be monitored by the external TAS-equipped monitoring device which in turn is controlled by the external middleware server linked to a farm of systems and databases (the Grid) as shown in FIGS. 1 and 2.

These small bodies can be made of various materials, including metal.

The bodies can be made of a substance that can interact with electromagnetic coils, internally or externally. This allows signals to be generated by the passage of the small bodies past a certain point or points. Hence by measuring the time interval, the velocity of the bodies can be established. In the same fashion, the position of a metallic small body, can be controlled through the use of magnets, to locate these device wherever and whenever desired.

These small bodies can also be made of materials that are reflective to radiation and reflection anywhere in the electromagnetic, visible and invisible, and/or radio spectrum. Hence another embodiment uses a form of reflective bounce analogous to radar, to find the position of the small body or bodies.

In another embodiment, the small bodies emit a dye either at a specified time, or based on receiving a command. This emission allows x-ray type visualization to be used to pinpoint the position. Scanner types—MRI, CAT, PET and the like can be used to establish the position of the small bodies.

Any of this positional data can be established on a time scale to establish velocity of the small bodies. In the same fashion, the small-bodies could emit a radioactive isotope that could similarly be used to track position and positional changes. In another embodiment, the small bodies are fabricated from a radioactive or radiation emitting material.

A Doppler effect can also be used to detect the velocity.

In Physics, the product of Velocity and Pressure is a constant in fluid flow. Hence the pressure will increase just before an obstruction—partial or complete, and decrease just afterwards. Hence the velocity will decrease before and increase after. The small devices report their positions and/or velocity via sensing as discussed above. These velocity differences can be used to measure obstructions as a percentage of the occlusion, and also their location. The same measurement can be used in organs to locate masses.

Small bodies can be built as boxes that contain some substance or material. These boxes can be opened on a signal. In that fashion, medication, radiation emitting material, reflective material, reflective or marker dye, or whatever is desired, can be released where desired in the body.

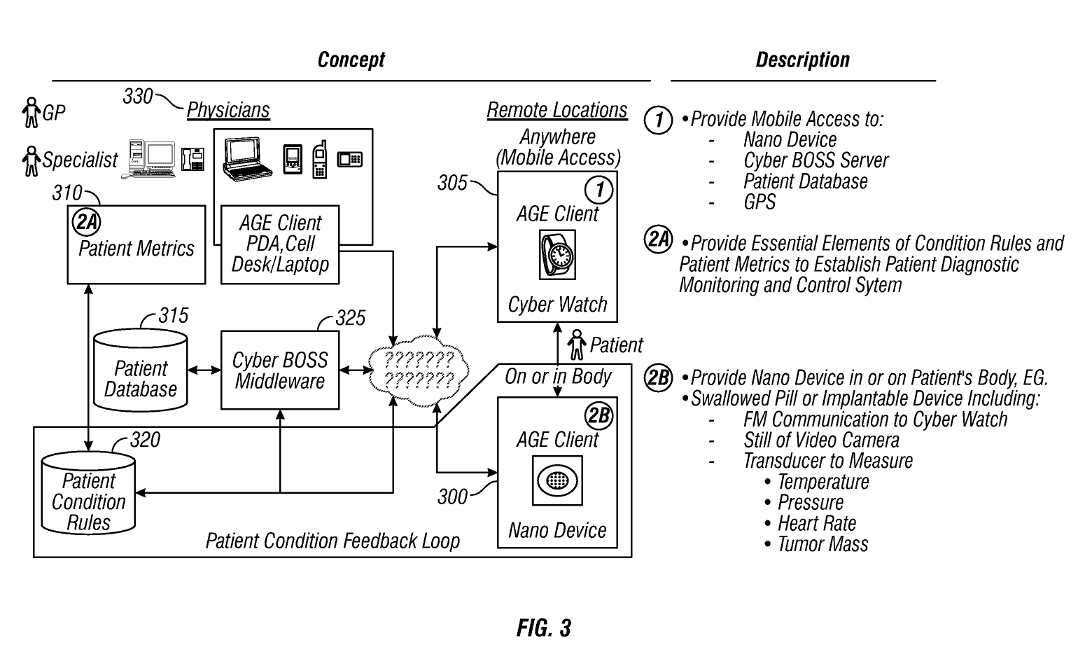

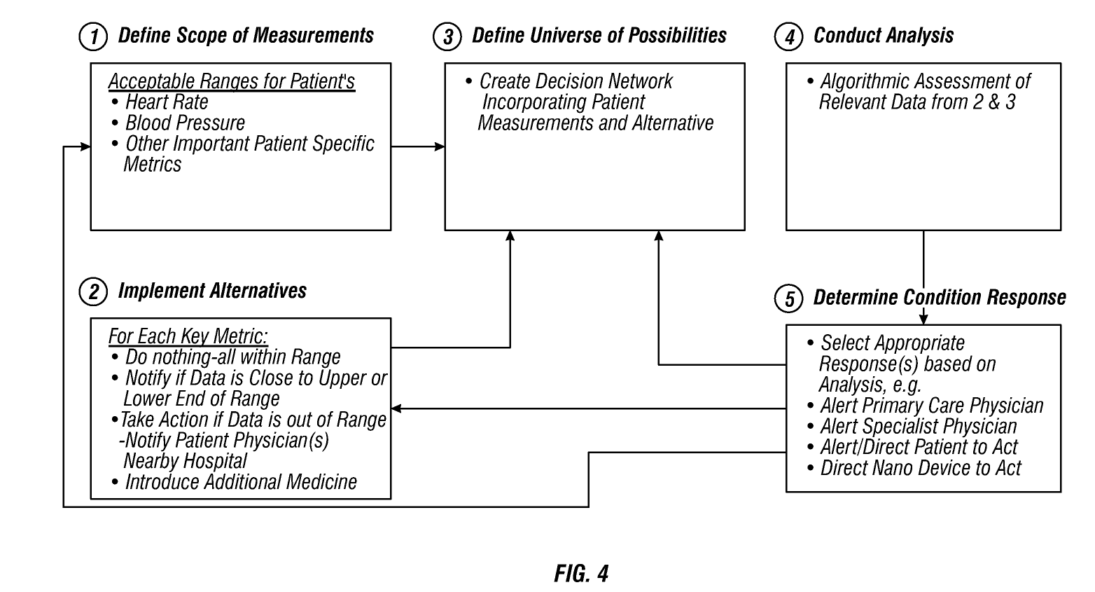

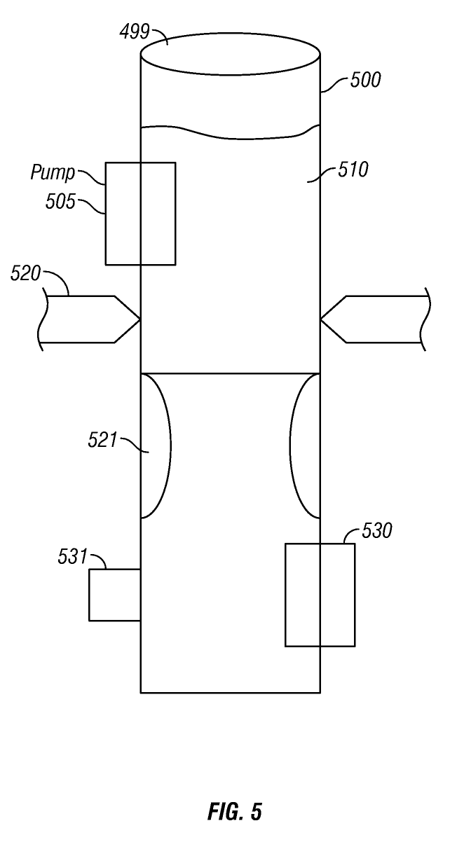

Chips are also decreasing in size and approaching the small level. Another embodiment uses small-chips imbedded with the small bodies that can make condition decisions based on the measurements or findings. For example, these chips can be located within stents in coronary arteries, within tumors, within organs, or wherever desired in the body. In that fashion, signals of a diverse nature can be two-way controlled externally by the thin client and middleware already mentioned as shown in FIGS. 1 and 2. This conditioned response is shown in FIGS. 3 and 4.

Embodiments include instrumentation to measure temperature, turbulence levels, and/or other desired measurements within the small bodies where such instrumentation is micro scaled to reside in the small bodies. Alternately, such measuring devices could be implanted within the body, in organs, or within blood vessels provided their dimensions are compatible with the location, and provided there is no adverse bodily function to such placement. Such implants can be temporary or permanent.

This type of response mechanism can function with or without small chips imbedded in the small bodies.

Power will be needed within the small bodies to emit signals, to control the opening and closing of ‘doors’, or to power any embedded chip. An important feature is to minimize power requirements. Small amount of power can be generated by the movement of the small bodies within the body, especially if circulating in the blood stream. As an alternative, these can be generated via chemical battery effects taking into account body fluids. Alternately, a small sized battery power can be imbedded.

The power requirements of the small devices can be minimal, or even nil according to the design objectives of the system. Because the small body is only a signaling device, its location alone can be determined by magnetic means, by pulses returned to an external source, by the power generated from the movement, or from a miniature battery. Temperature can also be monitored and transmitted by a power source within the body or if power can be generated by the motion of the body.

The system and methodology as described in the embodiments can be linked with known systems of medical imaging such as ultrasound, lasers, X-Ray, CAT Scan, PET Scan, MRI, and the like.

Hence, bodies of any metal or any other material can be used for monitoring, measuring, and/or delivering material anywhere in the living body; and the small bodies—with or without TAS, with or without micro chips, with or without battery power—can be located within or upon the human or animal body.

FIGS. 3 and 4 describe an alternative embodiment not previously possible. Because of the integrated capability as shown in FIG. 2, the information flowing from the body through a wrist monitoring device to a control server can be linked to any remote location. This provides the capability for controlled reaction based on occurrence relating specifically to the individual and the immediate circumstances of the body or the person.

FIG. 3 shows the ‘management by exception’ concept with feedback relating to the situation. With WiFi, bluetooth technology, low-level FM, cell towers, satellite or other readily available means of two-way wireless communication, this form of monitoring and control can be handled anywhere in within communication range. An embodiment shown in FIG. 3 allows the small bodies, such as 300, to be used to communicate via any kind of communicator 305. The patient metrics are communicated. These patient metrics may be stored in a patient database 315, and compared with patient condition rules 320. The middle ware 325 can carry out this comparison either locally or anywhere else. The physicians such as 330 can be remotely located, and can handle the communication at any of these locations.

The present system provides the ability to provide this medical monitoring capability anywhere, all the time, through wireless communication; and with much more accuracy through small-based devices in or on the body. The short range from the internal small body or small bodies to a receiver under the skin, on the skin, on the wrist, or carried would require minimal energy levels; leaving the bulk of the energy requirement to the receiver devices wherever they are to the external middleware which in turn is linked to the universe of systems and databases.

An embodiment is directed towards the linkage of transaction processing communication capability with small technology devices that might be implanted in or on the body, all as part of a UNI-LINK™ System. The data transport receiver and sender could be to a wristwatch, for example, which in turn could communicate globally with systems using WiFi in but one embodiment, as a communication medium. The end result is to provide monitoring, diagnosis potential, feedback control specific to the situation, direction to the subject, even delivery of medication. The universal nature of UNI-LINK® makes it possible to create new devices, as for example Wristwatch-like control units. In addition, the existing base of cell phones, PDA's, laptops, or PC's.

Today, it is appropriate to include the concept summarized here in another concurrently filed patent application that further explicates the original Martino concept and take advantage of an earlier priority date of invention. In addition to the technically groundbreaking aspects of the proposed invention, this approach can be used for this.

In summary, this invention provides a front-end device serving as an integral part of a three-tier system that could revolutionize certain aspects of critical healthcare diagnostics and prescription. The new solution would aim to improve patient safety worldwide at a much lower cost than is possible today.

In one embodiment, the front-end devices can combine a data gathering (sensing) capability with a communication capability the data gathering or measuring device could be a molecular-sized small technology pill or implantable device containing a camera, or a transducer to measure pressure-temperature-flow changes, as examples. This implantable device can wirelessly communicate with a network connected communication device in which the front-end single AGE program resides. The external device could be a wristwatch, a cell phone, a special unit combining cell capability with limited logic etc. This device would be called the Cyber Watch if that term can be trademarked. As interesting asides, the letters WW for wristwatch are the first part of WWW for World Wide Web, and wristwatch becomes both a timepiece and a watchful monitor.

An embodiment describes small sized device that is implanted in or on the human or animal body. This can be termed the ‘on-site kernel’, or just ‘kernel’. This kernel could be swallowed, inhaled, or placed into or on a vessel or any organ (even the heart) via needle; or injected into the bloodstream to move through the body to a pre-determined ‘deposit location’. The ‘kernel’ would measure flow, pressure, temperature, etc to determine locations of blockages, their extent, or their ‘mass’ if a tumor.

Another embodiment uses a small cyber monitor. This can broadcast messages and alerts in text, voice, sound or vibration mode, to the data entry device either on-demand or continuously, depending on the settings and the battery power requirements of the measuring device or the potential of employing blood flow as a battery charger in the measuring device. The small bodies may include emitters of signals on some wave band that can reside in the small bodies, broadcasting position and other information. In the same vein, transmitters can be positioned in blood vessels to transmit the passage of a small body equipped with a. Since the kernel would be close to the wrist containing a monitoring device, the energy requirement for the kernel is minimal. In one embodiment, this can be rechargeable by the body.

FIG. 4 shows a number of the metrics and operations with this system. This embodiment combines diverse technologies into one unified system to leverage the power of the individual components, and in the process, has the potential to establish a new paradigm for a less costly and more effective health care delivery system that elevates prevention to a standing equal to the current emphasis on post episodic treatment.

In the real world of aeronautics and aerospace, wind tunnels and other simulation devices are used for training and calibration purposes before real craft, devices, or flights are undertaken. In the same vein, this embodiment discloses a series of calibration experiments conducted in order to establish a correlation between findings in the body, human and/or animal, and their meaning in terms of disease, treatment, further examination, and/or medication.

The apparatus of an embodiment is shown in FIG. 5. A closed tube 500 has a pumping capability 505. The pump can be inside the tube 500, or outside.

The tube includes a fluid 510 of viscosity and composition to simulate body fluids or blood.

The tube also includes locations such as 520, 521 that can be crimped in various ways to simulate occlusions of flow of the tube. Instrumentation 530 which is internal or external to the tube can measure temperature, pressure, velocity of the flow, turbulence levels, and other such parameters associated with the flow. This apparatus can also have the ability to apply coronary catheter operations to simulate, test, and/or train persons in the use of such techniques.

Sensors 531 can also be external to the tube, and can measure parameters that change when sensed by wired coils, magnets (normal and electro type) which are placed to measure the interaction of the flow with such devices.

The tube has an injection port through which small and other bodies and particles can be introduced. This entry port can also be used for the catheter operations, or a second port can be installed. In fact, the number of ports in the tube can be variable.

MRI, Scanning, X-Ray and other visualization apparatus can be installed along the length of the tube at various locations useful for testing and experiment. Laser, ultrasound, radar, and other monitoring and measuring apparatus can similarly be located along the tube at diverse locations as needed.

All of the instruments can be individually calibrated, and their readings can be displayed on a common display, or can be directly entered into an associated computer recording device. Sounds can be recorded as well as measurements. An exit port, or ports, for removing miniature devices and particles can be used in addition to the use of any entry port if desired for such purposes.

The tube can be cylindrical in shape, or modified to other shapes, and is preferably closed, e.g., at the end 499. The tube can be made of any material so long as there is no interaction between the fluid in it and the walls of the enclosure. The preferred substance is rubber or pliable plastic.

The dimension of the tube can be variable. For testing purposes, it might be tailored to the size of the vessels to be simulated. Hence the instrumentation preferably should be separate from the tube in order to vary the tube dimensions with the same instrumentation. A preferred embodiment is a tube with ends that connect such that separating the tube ends can allow retraction of the tube from a fixed enclosure with instrumentation. A new tube can then be threaded through the enclosure and then connected at its ends. On the other hand, the enclosure for the instrumentation can be removed from the tube and the tube changed.

With the apparatus thus built, protocols for various research studies and training operations can be created. These studies should be conducted at three levels, in somewhat sequential order. The levels may include, for example:

(a) General Physics

(b) Body (animal and then human) interaction with small devices,

(c) System testing combining small and communication technology for monitoring, diagnosis, and medical treatment and control,

The first of these can be conducted in the apparatus designed as described above. The others would be an interaction between animal and human subjects and the simulation device. Hence the operation of the methodology and apparatus of this invention is interactive in nature with these later phases.

The protocols developed can become a means of extension of studies, and more importantly, provide for verification, repetitive testing, and duplication of findings in more than one location of both tube and testing facility.

The objectives of the study in basic Physics may include:

1 Establish the general physics of small bodies traveling in a fluid in a circular closed circuit pathway with an imposed single-source pulsating pressure (similar to a heart beat). This closed circuit pathway should be instrumented to measure variations in pressure, velocity of flow, and turbulence level. These measuring locations should be both inside and outside the enclosure. At various intervals along the flow path, variable constriction capability should be available to simulate the effect of occlusions at various percentage blockages. The pathway could very well be a stiff rubber tube of about half-an-inch in diameter common in laboratory use.

Conduct a series of experiments with flow in the pathway with and without variations due to creating one or more occlusions of varying percentage in the flow.

These experiments can be carried out with and without small devices added to the flow. If possible, these tests can be performed with one device, and then with a varying number of such devices in a stream.

These establish the potential of generating signals from such moving small bodies, including the generation of power; even an infinitesimal amount. The potential control of the small movement can be controlled with electromagnetic forces applied in various ways.

The relationship of signals from the small devices can be measured with known pressure, velocity, and turbulence levels in the fluid stream, especially with and without partial closure at the imposed occlusion locations, both before and after the closures.

One can establish ways of amplifying the signal and power level from the small devices, e.g., by experimenting with different material, especially metal, in constructing the small device. The initial protocols can be amplified in a search for ways to enhance the signal strength from the small devices. Then, the distance attenuation factor can be measured in collecting the small device signals; and used to develop receiver capability to collect the signals prior to transmitting them to thin-client equipped devices, e.g., at a distance of less than four feet.

The protocols for the follow-on studies with body-small devices interaction, and with integrated systems can be monitored. These studies can be conducted somewhat in parallel.

The results of these studies are used to design a series of experiments involving the interaction of small devices implanted in the body, in organs, or blood streams. These studies might first be conducted with animals, and then in humans.

On a parallel effort, the UNI-LINK system, described in our copending application 60/970,875 is used to interact with signals from the small devices. The collectors are designed and breadboarded as an initial part of this phase. Collector devices are considered as implants under the skin similar to heart pacers, or in devices on the body and possibly on the wrist, as for example a Cyber Watch. Tests can be conducted with the tube apparatus to measure the effectiveness of the various approaches as simulations in concert with actually testing with living bodies.

### ECONOMIC AND SOCIAL VALUE OF THIS INVENTION

The population is aging and will require more health care services in the coming years.
The US Health Care System as we know it today, cannot be economically sustained in the long term.
Practical measures that prevent major health problems will assume greater importance and value as the costs of treatment continues to adversely affect the majority of our society.
The National Institutes of Health's National Heart Attack Alert Program urges hospital emergency departments to reduce delays in treating heart attack patients. The goal is to treat heart attack patients within 30 minutes of arrival in the emergency room.
Each year, approximately 543,000 men and 399,000 women suffer heart attacks. In part because women have heart attacks at older ages than men do, women are more likely to die from an attack within a few weeks. Of the approximately 500,000 fatal heart attacks per year in the U.S., nearly half occur in women.
Within six years of a heart attack, 18 percent of men and 35 percent of women will suffer another heart attack, and seven percent of men and six percent of women will experience sudden death.
Within 6 years after a recognized heart attack:

18% of men and 35% of women will experience sudden death.

22% of men and 46% of women will be disabled with heart failure.*

Expenditures for coronary heart disease in the U.S. were estimated to exceed $142.1 billion in 2005*. ° Estimated deaths worldwide due to coronary heart disease total 7.1 million per year.

Figures were based on projected costs of physician and other professionals, hospital and nursing home services, medication costs, home health and other medical durables, as well as indirect costs associated with lost productivity because of morbidity and mortality. Source: American Heart Association. 1998 Heart and Stroke Statistical Update.

It is our belief that the United States must insure that the miracles of technologies that exist and that are on the cutting edge of development be harnessed to yield the economic and social benefits that their integration can make possible.

This kind of innovation, creatively applied to a growing problem in health care service delivery, should be pursued vigorously and relentlessly for it is in areas such as this that the US will maintain its leadership in technology and bring these benefits to the global community.

The general structure and techniques, and more specific embodiments which can be used to effect different ways of carrying out the more general goals are described herein.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Also, the inventor intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

I claim:

1. An apparatus for simulating movement of fluid in a living body, comprising:
a tube with instrumentation associated with areas of the tube, said instrumentation determining a characteristic of a movement of said fluid within the tube, and creating a calibration value indicative of said movement in said tube.

2. An apparatus as described in claim 1 with a fluid circulating part in the said tube, including a fluid circulating device, pulsed with a pressure generator.

3. An apparatus as described in claim 1 wherein said instrumentation operates for measuring one of temperature, pressure, turbulence levels, velocity of the fluid.

4. An apparatus as described in claim 1 further comprising crimping an outer surface to simulate occlusions or mass in the tube, said instrumentation measuring a calibration value associated with said occlusions.

5. An apparatus as in claim 1 further comprising visualization measurement structure which includes at least one of a scanner, ultrasound, magnetic resonance detector, magnetic manifestation detector or electrical manifestation detector.

6. An apparatus as in claim 1 wherein said tube includes entry and exit ports.

7. A method comprising:
using at least one body within a tube to simulate at least one physical process within a body;
communicating information from said body in said tube to a remote processing part; and
using said information to calibrate an operation within a human body.

8. A method as in claim 7, wherein said body is formed of a material that can be sensed by external structure outside the tube, and further comprising using said external structure to sense said body.

7. A method as in claim 1, further comprising allowing said material to emit a material

8. A method as in claim 1, wherein said two-way communication comprises communication which defines a location of said body, and the velocity of said body.
